(19) United States
(12) Patent Application Publication
(10) Pub. No.: US 2012/0142421 A1
(43) Pub. Date: Jun. 7, 2012

(54) Device for interactive entertainment

(76) Inventor: Thomas William Kennedy, JR., Dallas, TX (US)

(21) Appl. No.: 12/928,037

(22) Filed: Dec. 3, 2010

(51) Int. Cl. A63F 13/02

(52) U.S. Cl. 463/39

(57) ABSTRACT

A user participates in a real-life event wherein the results of the user's participation are displayed in a virtual environment. Said user can move in response to a real-life event, and those movements can be detected and processed to create a result.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A “MICROFICHE APPENDIX”

Not Applicable.

### BACKGROUND OF THE INVENTION

1. Field of the Invention Art

The present invention relates generally an entertainment device that allows a user interact with real-life events to produce virtual results. The user actions are measured and an appropriate response is translated into the virtual environment.

2. Description of the Related Art

Early virtual environments used joysticks for the purpose of user input. While joysticks are still used, input migrated to controllers with several buttons. Those buttons are used to control, for example, the movements of a character through a virtual world. New controllers have emerged where movements of the user are measured by the controller and/or sensors and those movements are translated into character movements in the virtual environment of the video game. The present invention allows a user to interact with a real-life event, such as a Major League Baseball game, wherein the user's movements are registered in a virtual environment.

### SUMMARY OF INVENTION

An object of this invention is to provide a device that allows a user to virtually participate in a real-life event. For example, the device takes data from a Major League Baseball game along with input data from a controller and/or sensors to allow a user to swing at a pitch from a real baseball game and produce a virtual result, such as a homerun.

Another object of this invention is to provide a learning or practice tool such that a users' actions can be practiced in real-life situations, but with only virtual results.

Another object of the invention is to provide a competition between several users of the device. Users will be able to compete against each other, for example, over the internet.

### BRIEF DESCRIPTION OF THE SEVERAL VIEWS OF DRAWINGS

The foregoing summary as well as the following detailed description of the preferred embodiment of the invention will be better understood when read in conjunction with the appended drawings. It should be understood, however, that the invention is not limited to the precise arrangements and instrumentalities shown herein. The components in the drawings are not necessarily to scale, emphasis instead being placed upon clearly illustrating the principles of the present invention. Moreover, in the drawings, like reference numerals designate corresponding parts throughout the several views.

The invention may take physical form in certain parts and arrangement of parts. For a more complete understanding of the present invention, and the advantages thereof, reference is now made to the following descriptions taken in conjunction with the accompanying drawings, in which:

FIG. 1 depicts a baseball helmet with an installed camera

FIG. 2 depicts a television screen displaying a live baseball game.

FIG. 3 depicts a controller shaped in the likeness of a baseball bat.

FIG. 4 depicts a television screen displaying a virtual result relating to the live video game.

### DETAILED DESCRIPTION OF INVENTION

Current video game systems such as the Nintendo Wii allows a user engage in a virtual game of baseball wherein a television screen displays a virtual pitch and the user responds by swinging the controller in a manner similar to a baseball bat. Sensors in the controller and/or in the surrounding environment determine whether the user has hit the ball as well as the path of the batted ball. In an embodiment of the present invention, a user participates in a similar, virtual baseball game. That embodiment, however, begins with a real-life baseball game in which the user swings at a real-life pitch, and a virtual result occurs such as the displaying of the effect of the swing, i.e., a batted ball or missed pitch. In addition to that example, the invention can indeed take the form of any type of real-life input to virtual output experience. For example, in addition to a game environment, the invention can be embodied in a manner focused on instruction, practice, or education.

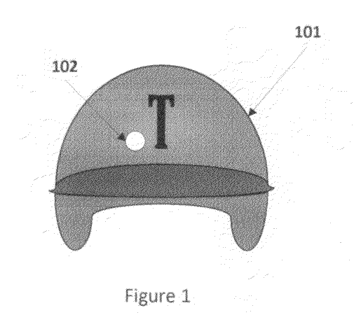

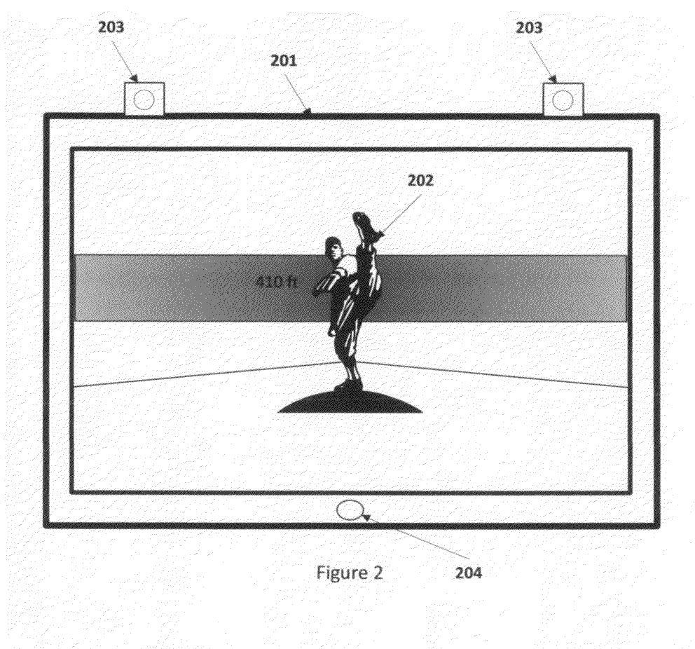

FIG. 1 depicts a batting helmet 101 with an installed camera 102. Camera 102 captures the perspective of the batter during his at bat. The video captured by camera 102 is reproduced on television screen 201 as shown in FIG. 2. As one of ordinary skill in the art will understand, camera 102 can be placed in many different locations in addition to the helmet of the batter. For instance, a camera can be placed in the mask of the catcher or the mask of the umpire; it can be mounted behind home plate or placed somewhere else in the ballpark, such that a video of the pitch can be captured. Furthermore, the pitch data can be captured by other sensors in addition to cameras. For instance, the speed of the pitch may be determined by a radar gun, and the location of the pitch may be determined by other sensors located around the plate.

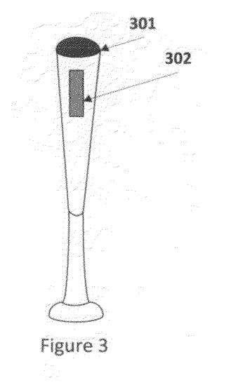

As television screen 201 displays the pitcher 202 delivering the ball in the real-life game, a user swings a baseball bat style controller 301, as depicted in FIG. 3, in an attempt to virtually hit the ball. In addition to a baseball bat style controller, controller 301 can be of any shape and size. Controller 301 contains sensors, which can determine the speed of the swing, the timing of the swing, and/or the position of the swing. Controller 301 may also contain another, smaller controller 302 that can be inserted into the bat. Controller 302 may contain its own sensors and be insertable in other larger controllers, such as a guitar for a music game. Controller 301 may be used by itself to determine the speed of the swing, the timing of the swing, and/or the position of the swing. In addition, sensors can be placed in the environment of television 201, such as on top of the television, as shown by sensors 203, or integrated with the television as shown by sensor 204. Although FIG. 2 depicts sensors 203 on top on the television screen and sensor 204 in the television, sensors may be placed anywhere in the environment of the user. Those sensors may be used in conjunction with the controller to determine the speed of the swing, the timing of the swing, and/or the position of the swing. Sensors such as sensors 203 and 204 may also be used without a controller sensor, such as controller 301, to determine the speed of the swing, the timing of the swing, and/or the position of the swing. In that instance, users may merely swing their arms or they may swing a regular baseball bat or any other instrument they find suitable to participate in the game. Furthermore, an ordinary, sensor-less controller can be used to play the game, if a user does not wish to swing a bat or make the physical exertion of waving his or her arms. It is also possible for the video game to include a mat that mimics a baseball home plate, in which the mat can display where the pitch crossed the plate, where the batter swung in relation the pitch, when the batter swung in relation to the pitch, and so forth.

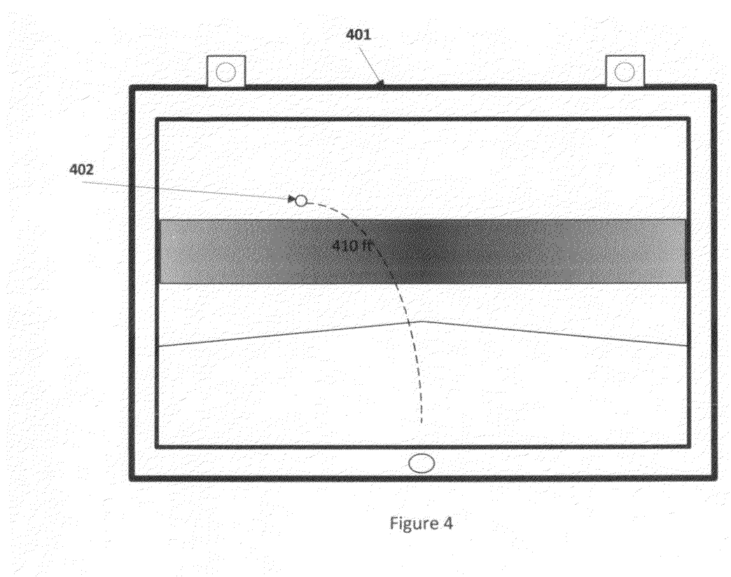

A processor or processing system located in a separate console, the television, an offsite processing area or another suitable location analyzes the data from swing sensors and the data from the live game camera, cameras, and or sensors and determines whether the user has hit the ball, and, if so, where the ball has been hit. Television screen 201 switches from displaying the live game to the virtual results of the swing as shown in FIG. 4. In FIG. 4 television screen 401 displays the trajectory of ball 402 as it travels through the air. The field used for the virtual results can be a reproduction of the actual ballpark in the live game, and sounds from the live game can be used as reactions to the user's virtual hit. Television screen 401 can also be split such that it displays the result of the virtual swing on one side and continues to display the actual game on the other side. Television screen 401 can further be split to display any configuration as the user desires, such as a continuing results screen, e.g., a list of longest balls hit, on one side, and a switch between the live game and virtual results on the other side. In that way, a user can play the game on one side of the screen, while having results displayed continuously on the other side. Television screen 401 can be further customized so that multiple, live games are used during the same gaming session. For example, if two live baseball games are being played at once, television screen 401 can alternate between the two games, such that the video game player can increase the number of pitches faced. Television screen 401 can display a pitch from the first game, the results of the swing, then a pitch from the second game, the results from that swing, and so forth.

The player of the game can change the settings such that a handicap can be applied. For example, the game can be set such that it approximates the actual physical results of the swing of the bat, but, because the video game player is not as skilled as the professional players competing in the live game, the video game player may not ever be able to hit the ball. To make hitting easier, the video game player can set a handicap such that making contact with the ball is easier by way of the ball being virtually delivered to the plate slower, by way of the ball being virtually bigger, by way of the bat being virtually bigger, or in any other manner to make hitting the ball easier for the video game player. Furthermore, the game can be set such that it applies the correct laws of physics to determine the trajectory of the ball, or the game can be set such that the physical rules are adapted to increase game player performance. If adapted physical rules are used, a struck ball can travel farther than under normal physical conditions, a swung bat can be swung faster than under normal physical conditions, and so forth.

Results of the game can be kept such that the various players of the game can compete against each other. For example, two players located in different physical locations can compete in the game against each other over the internet, such that the person with the most hits wins. The game also allows recording keeping of the best players in a variety of ways. For example, records can be kept ranking batting average for the whole season; ranking longest hit of the day; ranking the least strikeouts per at bat; ranking the player with the best average against a particular pitcher; ranking the player with the best ability to hit a fastball faster than 95 miles per hour; or any feasible record of the like. This type of record keeping allows for any number of possible competitions. For example, a single player in Boston can compete against another player in San Francisco in any number of different categories. Teams can be also assembled for competitions. For example two different sports bars can compete against each other so that, if New York is playing Texas, a Texas sports bar can assemble a team to bat against New York pitchers, and a New York sports bar can assemble a team to bat against Texas pitchers. Of course, several players can compete with each other in a home environment as with a typical video game.

The data captured from in-game cameras can be stored so that pitches may be reproduced. Storage of that data allows for several game play options. For example, storing pitch data allows for players all playing at the same location to swing at the same pitch in succession. In that example, if four players are playing the game, the first player swings at the pitch in real-time or near real-time as the pitch is being delivered. Results of the first player's swing are generated and the second player is then allowed to swing at the same pitch. The second player's results are displayed, and the game continues until all four players have swung at the same pitch. Stored pitches may also be used to create a variety of challenges, such as facing the ten best fastballs of the year; the ten best closers of the year; the ten least hit pitches of the year; the ten biggest softballs of the week; and so forth.

While the foregoing description has been set forth describing the invention as it relates to baseball. The present invention can also be applied to other sports and also outside of the area of sports. For instance a virtual video game player can drive alongside a live NASCAR race, can play during a live PGA Tour event, race alongside a live bicycle race such as the Tour de France, throw football passes during a live NFL game, kick soccer balls during a professional soccer game, shoot baskets during an NBA game, participate in a live surgery, or participate in any other live event.

In the race car embodiment of the invention, a user can participate in a live or stored actual car race. A video game player can use a normal, sensor-less video game controller, a steering wheel controller, a sensor based controller, or hand movements detected by environmental sensors to control the car. The video game player controls his or her own virtual car, which is superimposed onto the race data of the actual race. As with the baseball embodiment, the race car embodiment can utilize the handicap features, competition features, stored data features, display features, or any other features as described above.

In the golf embodiment of the invention, a user can participate in a live or stored actual golf game. A video game player can use a normal, sensor-less video game controller, a golf club shaped sensor based controller, or hand movements or golf club movements detected by environmental sensors to control the swing. The video game player controls his or her own virtual player, which is superimposed into a live or stored golf group. In this way, a video game player can play with a group of professional players as they play a round of golf. As with the baseball embodiment, the golf embodiment can utilize the handicap features, competition features, stored data features, display features, or any other features as described above.

In the bicycling embodiment of the invention, a user can participate in a live or stored actual bicycle race. A video game player can use a normal, sensor-less video game controller, a bicycle controller with or without sensors, or body movements detected by environmental sensors to control the bicycle. The video game player controls his or her own virtual player, which is superimposed into a live or stored bicycle race. In this way, a video game player can race a group of real life bicycle racers. As with the baseball embodiment, the bicycle embodiment can utilize the handicap features, competition features, stored data features, display features, or any other features as described above.

In the football embodiment of the invention, a user can participate in a live or stored football game. A video game player can use a normal, sensor-less video game controller, a football shaped sensor controller, or body movements detected by environmental sensors to control a virtual player. The video game player controls his or her own virtual player to participate in a real life football game. For example, in the football game a video game player might participate on a delay with a live game or in a stored game. On a delay, the player can attempt to run through the same hole as a running back just ran through, the player can attempt to make a pass that a quarterback just completed, the player can attempt to kick a field goal that was just kicked, or any similar activity. In this way, a video game player can participate in a real life football game. As with the baseball embodiment, the football embodiment can utilize the handicap features, competition features, stored data features, display features, or any other features as described above.

In the soccer embodiment of the invention, a user can participate in a live or stored soccer game. A video game player can use a normal, sensor-less video game controller, a soccer ball shaped sensor controller, or body movements detected by environmental sensors to control a virtual player. The video game player controls his or her own virtual player to participate in a real life soccer game. For example in the soccer game, a video game player might participate on a delay with a live game or in a stored game. On a delay, the player can attempt to dribble past an opposing player as just happened in the game, the player can attempt to make a pass that a player just made, the player can attempt to kick a goal that was just kicked, or any similar activity. In this way, a video game player can participate in a real life soccer game. As with the baseball embodiment, the soccer embodiment can utilize the handicap features, competition features, stored data features, display features, or any other features as described above.

In the basketball embodiment of the invention, a user can participate in a live or stored basketball game. A video game player can use a normal, sensor-less video game controller, a basketball shaped sensor controller, or body movements detected by environmental sensors to control a virtual player. The video game player controls his or her own virtual player to participate in a real life basketball game. For example, in the basketball game a video game player might participate on a delay with a live game or in a stored game. On a delay, the player can attempt to make the same drive to the basket and shoot a layup to mimic a previous play, the player can attempt to shoot a three-pointer over a defender, the player can attempt to shoot a free-throw with the crowd's distractions in the background, or any similar activity. In this way, a video game player can participate in a real life basketball game. As with the baseball embodiment, the basketball embodiment can utilize the handicap features, competition features, stored data features, display features, or any other features as described above.

In the surgery embodiment of the invention, a user can participate in a live or stored surgery. A participant can use surgical instrument shaped sensor controller, or body movements detected by environmental sensors to control a virtual surgeon. The participant controls his or her own virtual surgeon to participate in a real life surgery. For example, in the surgery embodiment, a participant might participate on a delay with a live surgery or in a stored surgery. On a delay, the player can attempt to suture an open wound, repair a damaged organ, and so forth. As with the baseball embodiment, the surgery embodiment can utilize the handicap features, competition features, stored data features, display features, or any other features as described above. In this way, the disclosed invention can be utilized to allow virtual participant in a wide array of real-life events.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention.

In addition, while a particular feature of the invention may have been disclosed with respect to only one of several embodiments, such feature may be combined with one or more other features of the other embodiments as may be desired. Additionally, specific details may have been omitted inasmuch as such details are not considered necessary to obtain a complete understanding of the present invention, and are considered to be within the understanding of persons of ordinary skill in the relevant art

It is therefore contemplated that the claims will cover any such modifications or embodiments that fall within the true scope of the invention.

What is claimed is:

1. A system comprising:
a video game allowing a user to participate in a virtual sporting event;
an input from the user;
an input from a real-life sporting event, wherein said input from the user and said input from the real-life sporting event are used to produce a result in the virtual sporting event.

2. The system in claim 1, wherein the user's motion is at least part of said input from the user.

3. The system in claim 1 or 2, wherein at least one additional user participates in said virtual sporting event, and comprising:
an input from said at least one additional user, wherein said input from the at least one additional user and said input from the real-life sporting event are used to produce an additional result in the virtual sporting event

4. The system of claim 3 wherein said input from the user is adapted to accommodate the skill level of the user.

5. The system of claim 1, 2, 3, or 4 wherein said virtual sporting event is a baseball game, football game, basketball game, soccer game, NASCAR race, bicycle race, or golf game.

6. A system comprising:
a sports video game;
an input from a user, wherein sensors are used to detect the user's motion for use as at least part of said input from a user;
an input from a real-life sporting event;
a result displayed in said sports video game, said result being obtained at least in part from both said input from a user and said input from a real-life sporting event.

7. The system of claim 6, wherein multiple users compete in said sports video game over the internet in said sports video game.

8. The system of claim 6, wherein the input from a real-life sporting event comprises data from a camera at said real-life sporting event.

9. The system of claim 6, wherein multiple users compete in said sports video game for a prize or share of a buy-in.

10. A system comprising:
a sensor for use in a video game;
said sensor detecting movements of a user of said video game and translating said movements into input data for said video game such that said input data can be combined with data from a real-life event, to produce a result in said video game.

11. The system of claim 11, wherein said real-life event is a sporting event.

12. The system of claim 12, wherein said sensor is part a controller shaped to accommodate said movements of a user.

13. The system of claim 12, wherein said sensor includes a stationary sensor in the environment of said user of said video game.
